(19) United States
(12) Patent Application Publication
(10) Pub. No.: US 2016/0274790 A1
(43) Pub. Date: Sep. 22, 2016

(54) Method realizing a plurality of keys/buttons which positions are determined dynamically and passively

(71) Applicant: Yonggui Li, Qingdao (CN)

(72) Inventor: Yonggui Li, Qingdao (CN)

(21) Appl. No.: 15/149,074

(22) Filed: May 6, 2016

Related U.S. Application Data
(63) Continuation-in-part of application No. PCT/CN2016/070222, filed on Jan. 6, 2016.

(30) Foreign Application Priority Data
Jan. 12, 2015 (CN) 201510014843.1
Nov. 30, 2015 (CN) 201510861828.0

(51) Int. Cl. G06F 3/0488; G06F 3/041; G06F 3/0354; G06F 3/0484

(52) U.S. Cl. CPC G06F 3/04886; G06F 3/0484; G06F 3/04883; G06F 3/0414; G06F 3/03547; G06F 2203/04104

(57) ABSTRACT

A method realizing a plurality of keys/buttons which positions are determined dynamically and passively. When a plurality of fingers of a user's one or two hand(s) hold or touch a multi-touch pad/screen, a plurality of touch points will be produced. So, a plurality of keys/buttons which positions are determined dynamically and passively can be realized on the multi-touch pad/screen by means of the touch points being regarded as keys/buttons, and the fingers being matched with the keys/buttons one to one via the touch points, and losing and regaining of each of the touch points and its coordinates because of a corresponding finger's operation or changing of a coordinate value which represents a finger's press force among coordinates of each of the touch points because of a corresponding finger's operation being regarded as an operation of a corresponding key/button. After a key/button operation ends, the fingers still hold or touch the touch pad/screen.

### CROSS-REFERENCE TO RELATED APPLICATIONS

This application claims benefit of a PCT application No. PCT/CN2016/070222, filed on Jan. 6, 2016 and entitled “A method realizing a plurality of keys/buttons which positions are determined dynamically and passively”, and claims priority benefit of a China application No. 201510861828.0, filed on Nov. 30, 2015 and entitled “A method realizing a plurality of keys/buttons which positions are determined dynamically and passively on a multi-touch pad”.

### TECHNICAL FIELD

This invention relates to a method realizing a plurality of keys/buttons which positions are determined dynamically and passively on a multi-touch pad/screen.

### BACKGROUND ART

A PCT application with publication No. WO 2014/023118 A1 disclosed that a touch pad can be used as a plurality of side-keys of a handheld digital device's keyboard, but it did not disclose any implementation method in detail.

### SUMMARY OF THE INVENTION

When a plurality of fingers of a user's one or two hand(s) hold or touch a multi-touch pad/screen, a plurality of touch points will be produced correspondingly. In the present invention, through regarding the touch points as keys/buttons, and matching the fingers with the keys/buttons one-to-one via the touch points, and regarding losing and regaining of one of the touch points and its coordinates or changing of a coordinate value representing a finger's pressing force among coordinates of one of the touch points because of a corresponding finger's operation as an operation of a corresponding key/button, hence, a plurality of keys/buttons which positions are determined dynamically and passively can be realized on a multi-touch pad/screen. After each operation ends, the fingers still hold or touch the touch pad/screen.

By using a multi-touch pad/screen as a plurality of keys/buttons, a user need not align his/her fingers with the keys/buttons before operation like operating position-fixed keys/buttons, and also need not worry about pressing a wrong key/button in operation, a finger will press a right key/button forever, because a key/button's position is determined only after a corresponding finger presses down, i.e., a corresponding finger holds or touches the multi-touch pad/screen. In the partial following description, side-keys configured on a multi-touch pad/screen is the above-mentioned keys/buttons.

### BRIEF DESCRIPTION OF THE DRAWINGS

FIG. 1 is a perspective view of a mobile phone;

FIG. 2 is a left view of the mobile phone;

FIG. 3 is a right view of the mobile phone;

FIG. 4 is a front view of the mobile phone;

FIG. 5 and FIG. 6 are another side-key layout of the mobile phone;

FIGS. 7-14 are keyboard layouts corresponding to side-keys and side-key combinations of the mobile phone.

FIG. 15 is a front view of another mobile phone;

FIG. 16 is a left view of the mobile phone;

FIG. 17 is a right view of the mobile phone;

FIG. 18 is a back view of the mobile phone.

FIG. 19 is a perspective view of a curved screen mobile phone;

FIG. 20 is another perspective view of the mobile phone;

FIGS. 21-30 are keyboard layouts corresponding to side-keys and side-key combinations of the mobile phone.

FIG. 31 is a perspective view of a slide mobile phone.

FIG. 32 is a perspective view of a flip mobile phone;

FIGS. 33-38 are keyboard layouts corresponding to partial side-keys and side-key combinations of the mobile phone.

FIG. 39 is a front view of a tablet;

FIG. 40 is a perspective view of the tablet;

FIG. 41 is a back view of the tablet;

FIGS. 43-48 are keyboard layouts corresponding to partial side-keys and side-key combinations of the tablet.

FIG. 42 is a perspective view of another tablet;

FIGS. 49-52 are keyboard layouts corresponding to partial side-keys and side-key combinations of the tablet.

FIG. 53 is a front view of a tablet;

FIG. 54 is a perspective view of the tablet;

FIG. 55 is a back view of the tablet.

FIG. 56 is a perspective view of another tablet.

FIG. 57-64 are front views of a touch-pad mouse.

FIG. 65-68 are front views of a large touch-screen display device.

### DETAILED DESCRIPTION OF THE INVENTION

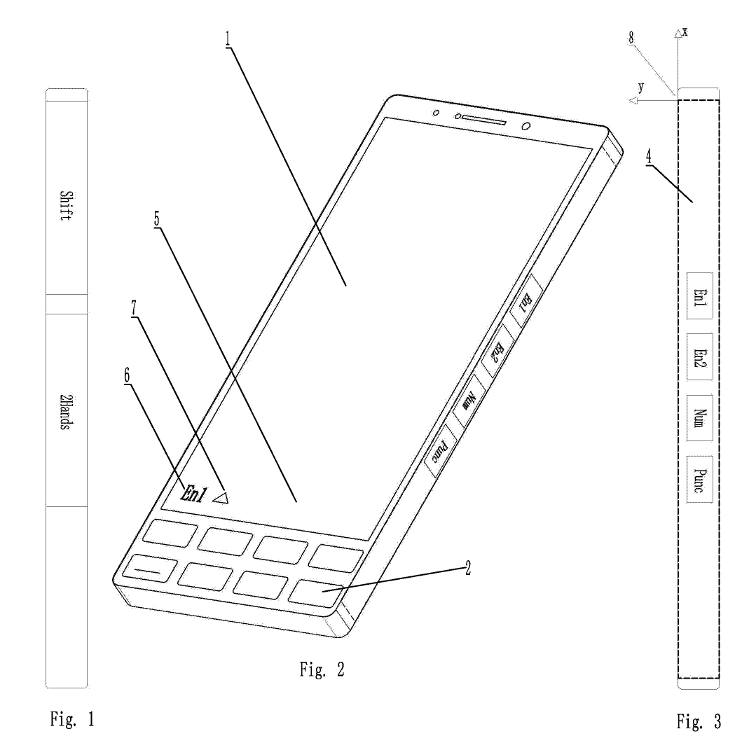

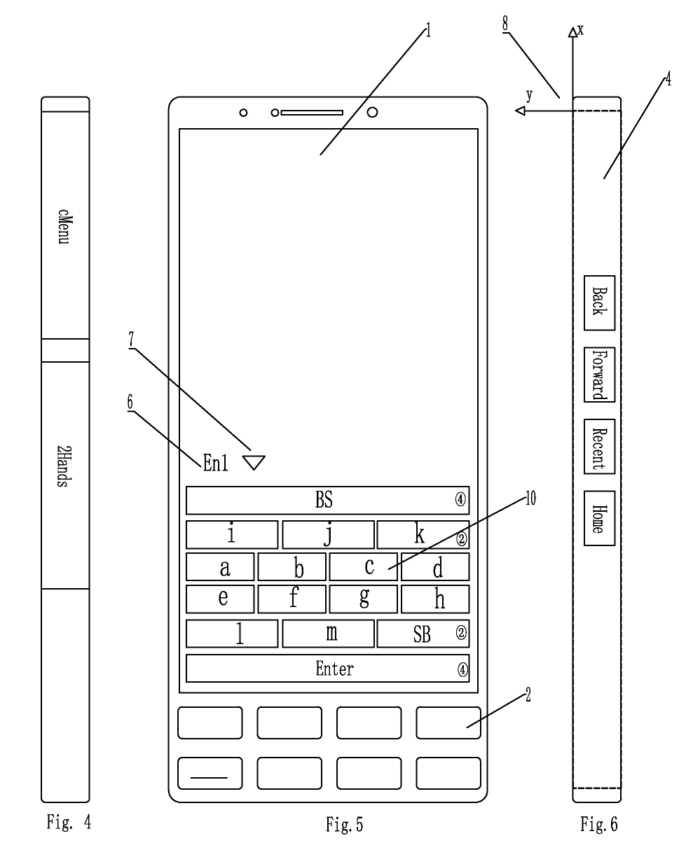

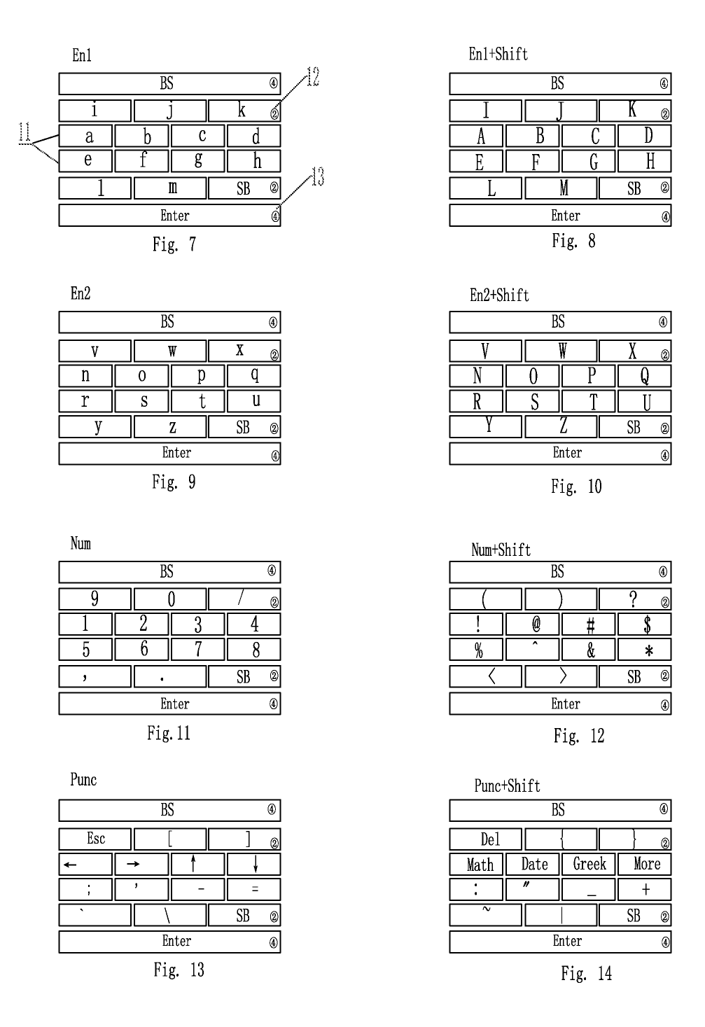

Part A. FIG. 1 is a mobile phone 1, a two*four matrix physical keyboard 2 is configured at its bottom, Shift and 2Hands side-keys are configured at its left side, En1, En2, Num and Punc side-keys are configured on a multi-touch pad 4 at its right side. A dynamically keyboard-mapping area 10 is configured on a touch screen of the phone 1. According to a currently operated side-key or side-key combination, the area 10 dynamically displays one of FIG. 7-14 keyboard layouts to help a user to operate on the keyboard 2. The area 10 itself can also be a touch keyboard. A side-key indicator 6 is used to indicate a currently operated side-key or side-key combination. A button 7 is used to close or open the area 10. A situation is shown as 5 when the area 10 is closed.

When a user's five left fingers hold the phone 1, the left thumb holds Shift side-key and the left index, middle, ring and little fingers hold the pad 4, the fingers' touch points on the pad 4 are side-keys, 2Hands side-key is pressed/touched naturally by a root bulge of the left thumb. The left hand holds the phone 1 and the side-keys and operates the side-keys, and a right hand operates the keyboard 2. The left index, middle, ring and little finger corresponds to En1, En2, Num and Punc respectively. En1 and En2 is for inputting 26 English letters, Num is mainly for inputting numeric characters, Punc is mainly for inputting punctuations, and Shift side-key's function is the same as a PC keyboard's Shift key's function.

A side-key is operated by means of a method releasing a finger corresponding to the side-key first and then pressing the finger down at once, the side-key is deemed to be pressed down when pressing the finger down again after releasing. After a side-key is deemed to be pressed down, when it is “released” is decided by a keyboard firmware according to another side-key operated next time. For example, when En1 and Shift are marked by the firmware as being pressed down (at this point, En1, Shift and the other side-keys are all pressed), and then if En2 is operated, the firmware will mark En2 as being pressed down and En1 and Shift as being released at the same time (even though the fingers pressing En1 and Shift are still not released). For another example, when only En1 is marked as being pressed down, and then if Shift is operated, the firmware will only mark Shift as being pressed down, in this way, a combination of En1+Shift is realized. The same analogy applies to the other situations.

Pressing/touching 2Hands side-key will trigger the keyboard firmware to detect whether Shift is pressed/touched and four touch points are produced on the touch pad 4. If yes, then the phone 1, Shift and the touch pad 4 are all held correctly, and according to a coordinate system 8, the firmware sorts the four touch points from largest to smallest by x value (i.e., from top to bottom), and stores the sorted touch points as pindex, pMiddle, pRing and pLittle, and then calculates an average of distances along x axis between every two adjacent points among the sorted touch points and stores it as avg, and then matches pindex, pMiddle, pRing and pLittle respectively with the left index, middle, ring and little fingers, and En1, En2, Num and Punc side-keys on the touch pad 4 one to one, and marks the left index, middle, ring and little fingers as pressing down.

And then the firmware activates the side-keys, and a side-key being deemed to be currently pressed down by default is En1, i.e., the firmware marks En1 as being pressed down and the other side-keys as being released, even though all the side-keys are touched by the five left fingers at this point.

After activating the side-keys, if the number of the touch points on the touch pad 4 changes: (a) the number is less than 3 but more than 0, then there are multiple fingers operating on the touch pad 4 at the same time, this situation will not be described in the following for simplicity; (b) the number is equal to 0, then all of the fingers on the pad 4 release, the keyboard firmware deactivates the side-keys and waits for a condition activating the side-keys to appear again; (c) the number is equal to 3, then only one finger on the pad 4 releases and is operating a certain side-key. The keyboard firmware sorts the 3 detected touch points from largest to smallest by x value into p31, p32 and p33.

(A) if p31.x<=pMiddle.x+avg*50% (avg can also be replaced by 20 mm in order to overcome a drawback that avg is inaccurate because a user's fingers' holding gesture on the pad 4 is too casual. 20 mm is an average value of finger widths of all races of adults, it is an empirical value. avg can also be determined by means of testing and verifying when a mobile phone is used first by a user), then the left index finger releases, the touch point of the left index finger and its coordinates are lost on the touch pad 4, the keyboard firmware marks the left index finger as releasing, and go to (D). If no, go to (B).

(B) if p33.x>pRing.x−avg*50%, then the left little finger releases, the touch point of the left little finger and its coordinates are lost on the touch pad 4, the keyboard firmware marks the left little finger as releasing, go to (D). If no, go to (C).

(C) if pMiddle.x−avg*50%<p32.x<=pMiddle.x+avg*50%, then the left ring finger releases, the keyboard firmware marks the left ring finger as releasing, otherwise, the left middle finger releases, the firmware marks the left middle finger as releasing. Then, go to (D)

(D) later on, if the keyboard firmware detects that four touch points are produced again on the pad 4, then the just releasing finger presses down again, the lost touch point corresponding to the finger and its coordinates regain, the firmware marks the finger as pressing down again and also marks the side-key corresponding to the finger as being pressed down at the same time, and simultaneously decides whether to re-mark the other side-key(s) having been marked as being pressed down before as being released. And then, the firmware sorts the newly detected four touch points from largest to smallest by x value into p41, p42, p43 and p44, and then use them to update pindex, pMiddle, pRing and pLittle respectively. After that, the keyboard firmware continuously detects and processes circularly as the above description.

Because each side-key's initial position on the touch pad 4 is determined by a corresponding touch point's initial position of a user's corresponding finger on the pad 4 and is not predefined, and moreover each side-key's position will continue to change following changing of a corresponding touch point's position in operation. Hence, if a multi-touch pad is used as a plurality of side-keys, a user does not have to align his/her fingers with the side-keys before operation like operating position-fixed side-keys, and furthermore does not have to worry about pressing a wrong side-key in operation, each finger will press a right side-key forever because a side-key's position is determined only after a corresponding finger presses down, i.e., a corresponding finger holds or touches the multi-touch pad/screen.

When a user's left finger double-click, a corresponding side-key layout is shown as FIGS. 5 and 6. Wherein Home is used as a Home button; Recent is for displaying recently opened App; Back and Forward is for navigation; cMenu is short for context menu and used to open or close a current app's menu (toolbar).

According to the phone 1's current App, on the touch pad 4, the left index finger slides upward to increase volume or page up, and slides downward to decrease volume or page down. FIG. 7 is a keyboard layout corresponding to side-key En1 of the phone 1, its two middle key rows 11 correspond to two key rows of the keyboard 2. A sign \textcircled{2} as 12 means that each key in a row where it is realized by simultaneously pressing down and releasing two corresponding keys in the keyboard 2. For example, i key is realized by simultaneously pressing down and releasing two corresponding keys: a and b. A sign \textcircled{4} as 13 means that each key in a row where it is realized by simultaneously pressing down and releasing four corresponding keys in the keyboard 2. For example, BS key is realized by simultaneously pressing down and releasing four corresponding keys: a, b, c and d. The same analogy applies to the other keys and the other keyboard layouts. A side-key or side-key combination corresponding to one of FIG. 7-14 keyboard layouts are labeled at the upper left corner of each keyboard layout.

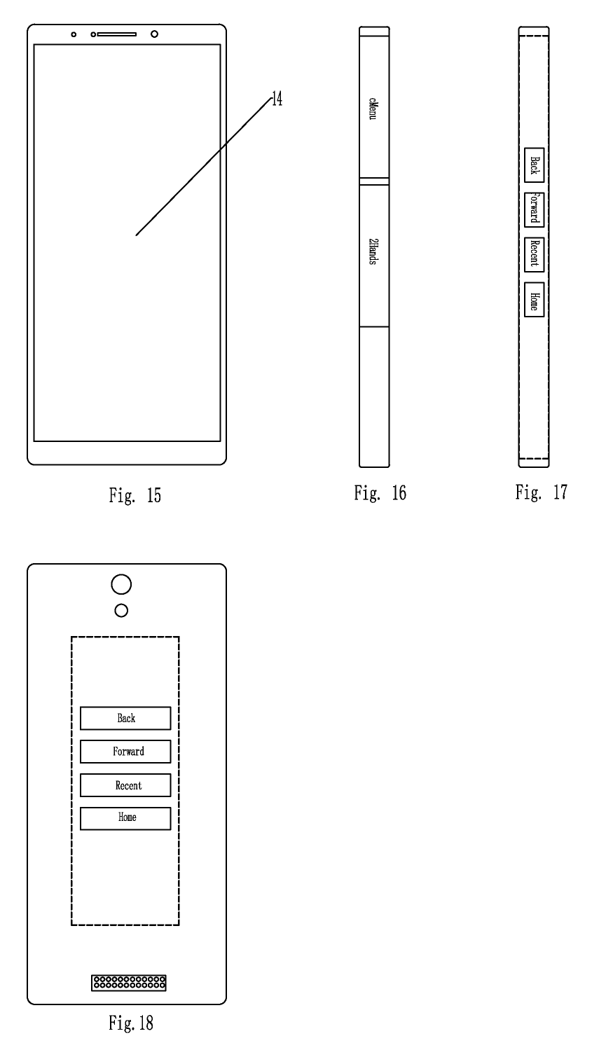

FIG. 15 is a mobile phone 14 too, cMenu and 2Hands side-keys are configured at the left side as FIG. 16, and Back, Forward, Recent and Home side-keys are configured on a multi-touch pad at the right side as FIG. 17 and a multi-touch pad in the middle of the back as FIG. 18.

The touch pad configured at the back of the mobile phone 14 is in order to facilitate a user to hold and operate the phone by a single hand (a left or right hand), in this situation, a missing cMenu side-key can be realized by an index finger's double-click on the back's touch pad. When a or some finger(s) of a hand holding the phone 14 operate on the back's touch pad, the thumb of the hand will touch the front touch screen, this kind of touch actions occurring concurrently with operations on the back's touch pad should be neglected. When a keyboard firmware detects that four touch points are produced on the back's touch pad, it activates the side-keys on the touch pad.

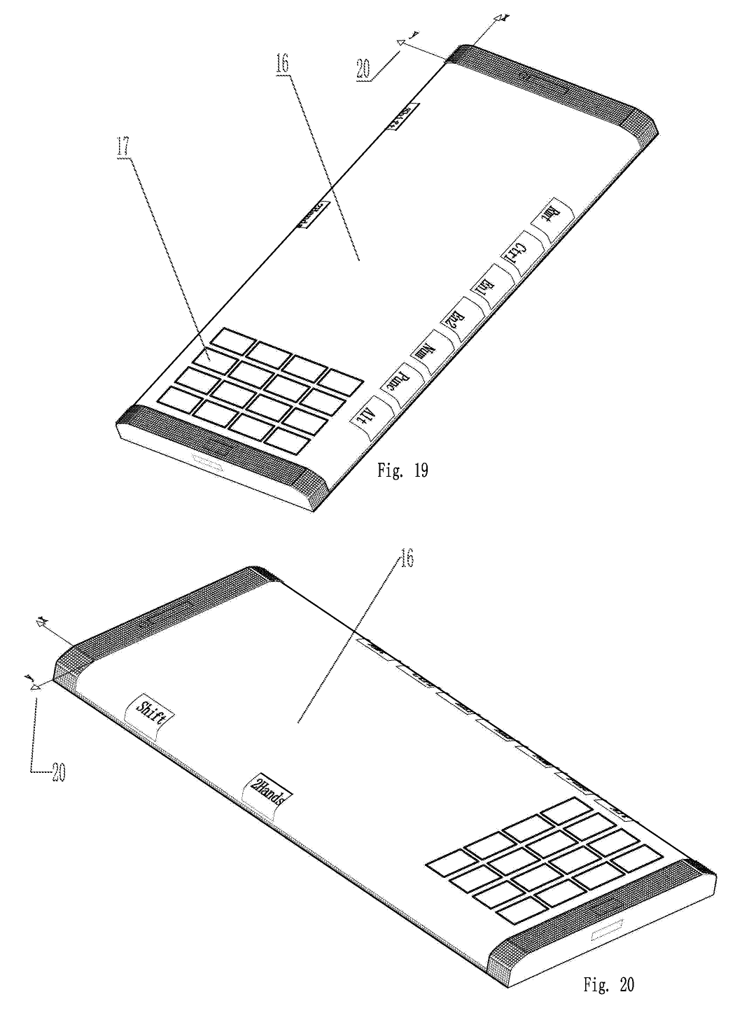

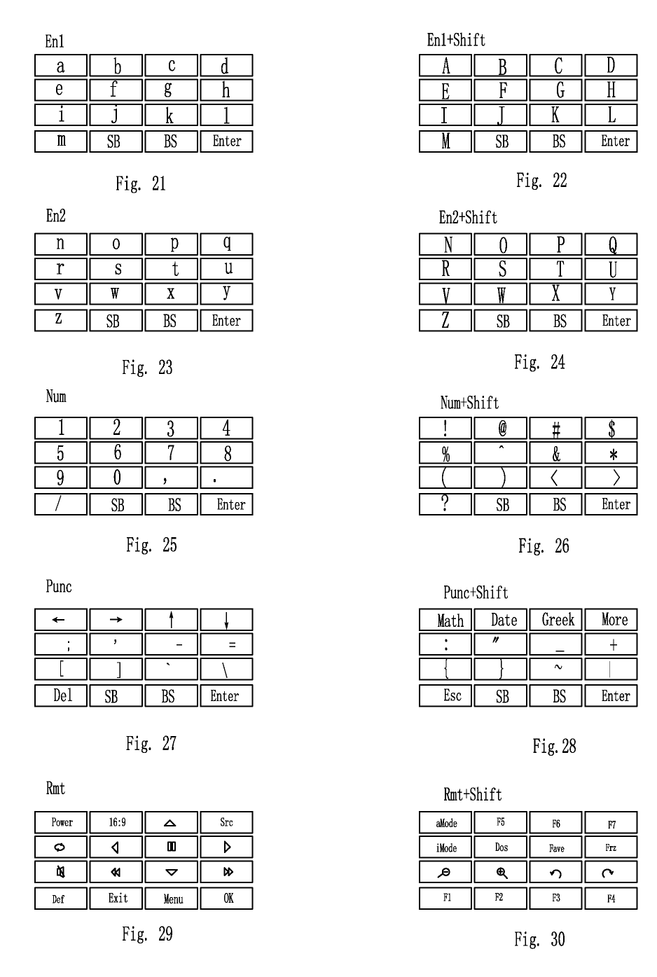

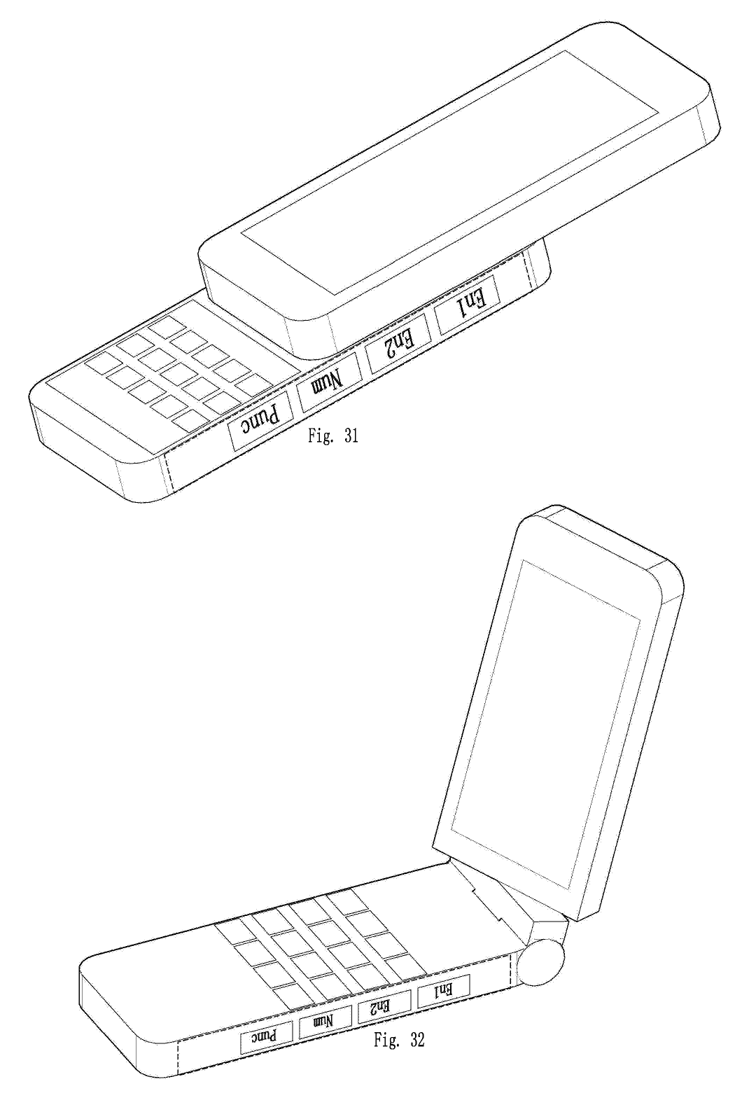

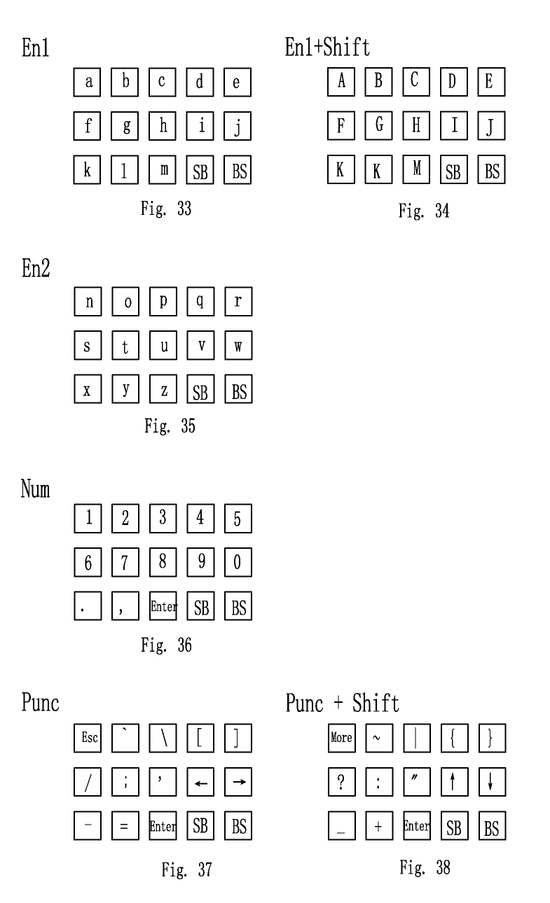

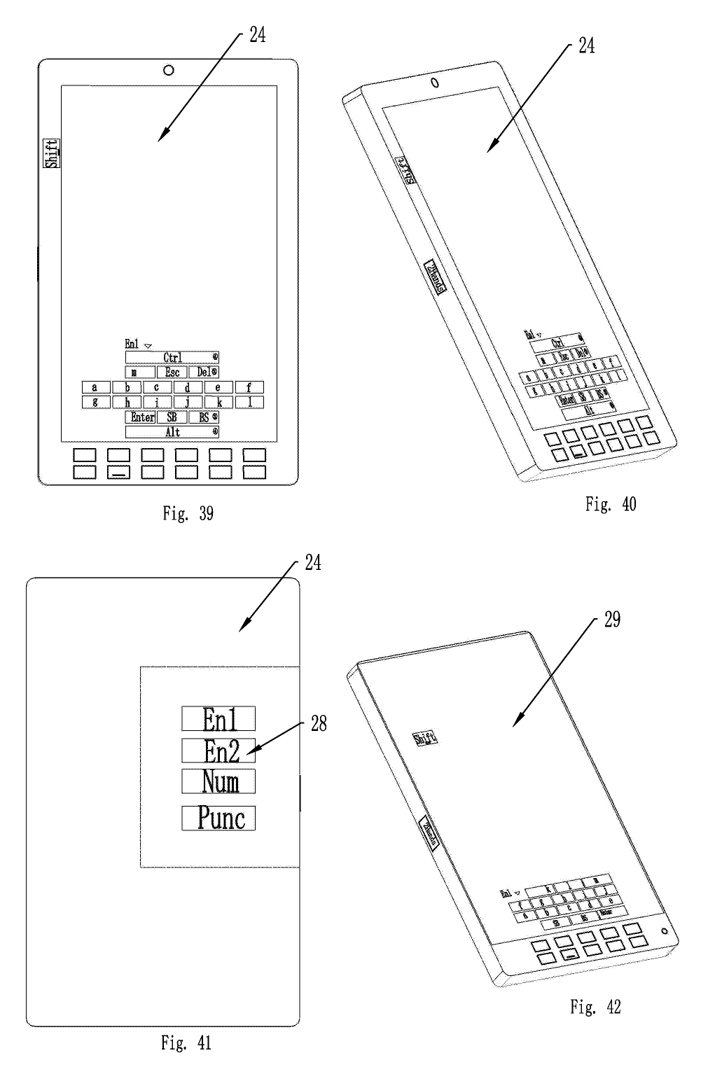

Part B. A curved screen mobile phone 16 is shown as FIGS. 19 and 20, its curved screen is a multi-touch screen. Shift and 2Hands side-keys are configured at the left of the curved screen, Rmt, Ctrl, En1, En2, Num, Punc and Alt side-keys are configured at the right of the curved screen. The phone 16 and the side-keys are held and operated by a user's left hand, Ctrl and Rmt are operated by the user's left index finger moving upward, and Alt is operated by the user's left little finger moving downward (if a lefty uses the phone 16, it is sufficient to swap side-key layouts at the left and right sides of the curved screen). A keyboard 17 is a 4*4 matrix touch keyboard configured on the curved screen, its layout changes dynamically according to currently operated side-key or side-key combination. A plurality of keyboard layouts corresponding to side-keys or side-key combinations of the phone 16 are shown as FIG. 21-30.

When a user's left hand holds the phone 16, the left thumb holds at the left side of the curved screen, the other four left fingers holds evenly at the right side of the curved screen. When the phone 16 detects that six touch points at the two sides of the curved screen are produced, sorts the four touch points at the right side from largest to smallest by x value according to a coordinate system 20, and calculates each distance along x axis between every two adjacent touch points among the four sorted touch points, each above distance is stored as a dist, and then calculates an average and a total of the above-mentioned distances, the average and the total are stored as avg and ttl respectively. If each dist is within avg*(1±25%) and ttl is within wdth*3*(1±20%) (wdth is an average width of a user's fingers and is predefined by 20 mm, and can be re-defined by a new value by means of testing and verifying when a user first uses a mobile phone), the phone 16 continues to determine whether a perpendicular distance from the first touch point to the top edge of the curved screen is larger than 2.5*avg and a perpendicular distance from the fourth touch point to the bottom edge of the curved screen is larger than 1.5*avg. If yes, the phone 16 activates the side-keys.

And then, the phone 16 stores the above four sorted touch points as pindex, pMiddle, pRing and pLittle, and matches them with the left index, middle, ring and little fingers and En1, En2, Num and Punc at the right side of the curved screen one to one respectively, and marks the left index, middle, ring and little fingers as pressing down. Meanwhile, as for the two touch points produced at the left side of the curved screen, the phone 16 matches the upper touch point with the left thumb and Shift, and matches the lower touch point with 2Hands. And then, the phone 16 marks En1 as being pressed down and the other side-keys (except 2Hands) as being released by default.

Shift, En1, En2, Num and Punc are operated by means of first releasing a finger corresponding to a target side-key and then pressing the finger down at once. After activating the side-keys, if the phone 16 detects that there are only three touch points (please refer to Part A for the other situations with different number of touch points being detected) at the right side of the curved screen, then there is a finger releasing at the right side of the curved screen and a certain side-key is operating. The phone 16 sorts the three detected touch points from largest to smallest by x value into p31, p32, p33.

(A) If p31.x<=pMiddle.x+avg*50%, then the left index finger releases and the touch point of the left index finger at the right side of the curved screen and its coordinates are lost, the phone 16 marks the left index finger as releasing. And later, if the phone 16 detects that four touch points are produced again at the right side of the curved screen, then the left index finger presses down again, the lost touch point of the left index finger and its lost coordinates regain at the right side of the curved screen, and the phone 16 re-marks the left index finger as pressing down. Meanwhile, the phone 16 sorts the four newly produced touch points at the right side of the curved screen from largest to smallest by x value into p41, p42, p43 and p44.

If pMiddle.x+avg*50%<p41.x<=pMiddle.x+avg*150%, then the left index finger presses down at the position of En1, the phone 16 marks En1 as being pressed down and the other side-keys (except Alt) as being released, i.e., after En1 is pressed, corresponding side-key and side-key combination may be En1 or Alt+En1 (if Alt has been marked as being pressed down before);

If pMiddle.x+avg*150%<p41.x<=pMiddle.x+avg*250%, then the left index finger presses down at the position of Ctrl, the phone 16 marks Ctrl and En1 as being pressed down and the other side-keys (except Alt) as being released, i.e., after Ctrl is pressed, corresponding side-key and side-key combination(s) may be Ctrl+En1, Ctrl+Alt+En1 (if Alt has been marked as being pressed down before).

If p41.x>pMiddle.x+avg*250%, then the left index finger presses down at the position of Rmt, the phone 16 marks Rmt as being pressed down and the other side-keys as being released.

And then, the phone 16 updates pindex, pMiddle, pRing and pLittle with p41, p42, p43 and p44 respectively.

(B) If p33.x>pRing.x−avg*50%, then the left little finger releases and the touch point of the left little finger and its coordinates are lost at the right side of the curved screen, the phone 16 marks the left little finger as releasing. And later, if the phone 16 detects that four touch points are produced again at the right side of the curved screen, then the left little finger presses down again, the lost touch point of the left little finger and its lost coordinates regain at the right side of the curved screen, and the phone 16 re-marks the left little finger as pressing down. Meanwhile, the phone 16 sorts the four newly produced touch points at the right side of the curved screen from largest to smallest by x value into p41, p42, p43 and p44.

If pRing.x−avg*150%<p44.x<=pRing.x−avg*50%, then the left little finger presses down at the position of Punc, the phone 16 marks Punc as being pressed down and the other side-keys but Ctrl as being released, i.e., after Punc is pressed, corresponding side-key and side-key combination may be Punc or Ctrl+Punc (if Ctrl has been marked as being pressed down before).

If p44.x<=pRing.x−avg*150%, then the left little finger presses down at the position of Alt, the phone 16 marks Alt and Punc as being pressed down and marks the other side-keys but Ctrl as being released, i.e., after Alt is pressed, corresponding side-key and side-key combination(s) may be Alt+Punc, Ctrl+Alt+Punc (if Ctrl has been marked as being pressed down before).

And then, the phone 16 updates pindex, pMiddle, pRing and pLittle with p41, p42, p43 and p44 respectively.

(C) If pMiddle.x−avg*50%<p32.x<=pMiddle.x+avg*50%, then the left ring finger releases, the phone 16 marks the left ring finger as releasing, otherwise, the left middle finger releases, the phone 16 marks the left middle finger as releasing. And later, if the phone 16 detects that four touch points are produced again at the right side of the curved screen, then the left middle or ring finger presses down again, the lost touch point of the left middle or ring finger and its lost coordinates regain at the right side of the curved screen.

If the left middle finger was marked as releasing just now, the phone 16 marks the left middle finger as pressing down and marks En2 as being pressed down and the other side-keys but Ctrl and Alt as being released at the same time, i.e., after En2 is pressed, corresponding side-key and side-key combination(s) may be En2, Ctrl+En2, Alt+En2 or Ctrl+Alt+En2 (if Ctrl and/or Alt have/has been marked as being pressed down before).

If the left ring finger was marked as releasing just now, the phone 16 marks the left ring finger as pressing down and marks Num as being pressed down and the other side-keys but Ctrl and Alt as being releasing at the same time, i.e., after Num is pressed, corresponding side-key and side-key combination(s) may be Num, Ctrl+Num, Alt+Num or Ctrl+Alt+Num (if Ctrl and/or Alt have/has been marked as being pressed down before).

And then, the phone 16 sorts the four newly detected touch points into p41, p42, p43 and p44, and updates pindex, pMiddle, pRing and pLittle with p41, p42, p43 and p44 respectively.

Part C. If the phone 16's curved screen is a 3D multi-touch screen, Shift, En1, En2, Num and Punc can be operated by means of first pressing a target side-key with a larger force by a corresponding finger, and then relaxing the corresponding finger at once into a naturally holding state. In this situation, a touch point of a finger on the curved screen is represented in (x, y, p), p is a press force of the finger on the touch point. After a finger presses with a larger force and then relaxes again, a corresponding side-key is marked as being pressed down, and when the corresponding side-key is “released” is determined by the phone 16 according to a subsequently operated side-key, for more information, please refer to the above Part A and B. For steps before the phone 16 detects operations of the side-keys, please refer to the above Part B.

After activating the side-keys, if the phone 16 detects that there are four touch points at the right side of the curved screen and a touch point's p value is changed and pressed with a larger force, and then the phone 16 sorts the four touch points from largest to smallest by x value into p41, p42, p43 and p44.

If (p41.p−pindex.p)/pindex.p>P (Capital P is a predefined value which can be used to distinguish correct and incorrect operations of a finger, and also can be defined by a new value by means of testing and verifying when a user first use a mobile phone), or p41.p>P1*fct, and

(a) If pMiddle.x+avg*50%<p41.x<=pMiddle.x+avg*150%, then the left index finger presses with a larger force at the position of En1, and then En1 is marked as being pressed with a larger force.

(b) If pMiddle.x+avg*150%<p41.x<=pMiddle.x+avg*250%, then the left index finger presses with a larger force at the position of Ctrl, and then Ctrl is marked as being pressed with a larger force.

(c) If p41.x>pMiddle.x+avg*250%, then the left index finger presses with a larger force at the position of Rmt, and then Rmt is marked as being pressed with a larger force.

If (p42.p−pMiddle.p)/pMiddle.p>P, or p42.p>P2*fct, then the left middle finger presses with a larger force at the position of En2, and then En2 is marked as being pressed with a larger force.

If (p43.p−pRing.p)/pRing.p>P, or p43.p>P3*fct, then the left ring finger presses with a larger force at the position of Num, and then Num is marked as being pressed with a larger force.

If (p44.p−pLittle.p)/pLittle.p>P, or p44.p>P4*fct (the above capital P1, P2, P3 and P4 respectively are press forces exerted on touch points by a user's left index, middle, ring and little fingers naturally holding at the right side of the curved screen, fct is a predefined factor able to distinguish correct and incorrect operations of a finger, and also they can be defined by new values by means of testing and verifying when a user first uses a mobile phone), and

(a) If pRing.x−avg*150%<p44.x<=pRing.x−avg*50%, then the left little finger presses with a larger force at the position of Punc, and then Punc is marked as being pressed with a larger force.

(b) If p44.x<=pRing.x−avg*150%, then the left little finger presses with a larger force at the position of Alt, and then Alt is marked as being pressed with a larger force.

Later on, if the phone 16 detects that the touch point's p value changes again and the four fingers all return to a naturally holding state at the right side of the curved screen, then undoes just marking the corresponding side-key as being pressed with a larger force and marks the side-key as being pressed down (when Ctrl is marked as being pressed down, En1 is simultaneously marked as being pressed down too, and when Alt is marked as being pressed down, Punc is simultaneously marked as being pressed down too), and further decides whether to mark the other side-keys having been marked as being pressed down before as being released at the same time. And then, the phone 16 sorts the four newly detected touch points from largest to smallest by x value into p41, p42, p43 and p44, and updates pindex, pMiddle, pRing and pLittle with them.

And after activating the side-keys, if the phone 16 detects that there are only three touch points at the right side of the curved screen, then there is a finger releasing at the right side of the curved screen. The phone 16 sorts the three touch points from largest to smallest by x value into p31, p32, p33.

(A) If p31.x<=pMiddle.x+avg*50%, then the left index finger releases, the phone 16 marks the left index finger as releasing. And later, if the phone 16 detects that four touch points are newly produced at the right side of the curved screen, then the left index finger presses down again, the phone 16 marks the left index finger as pressing down. And then the phone 16 sorts the four touch points from largest to smallest by x value into p41, p42, p43 and p44.

If pMiddle.x+avg*50%<p41.x<=pMiddle.x+avg*150%, then the left index finger presses down at the position of En1, and En1 is marked as being pressed down.

If pMiddle.x+avg*150%<p41.x<=pMiddle.x+avg*250%, then the left index finger presses down at the position of Ctrl, and Ctrl and En1 are marked as being pressed down.

If p41.x>pMiddle.x+avg*250%, then the left index finger presses down at the position of Rmt, and Rmt is marked as being pressed down.

After the above-mentioned corresponding side-key(s) is/are marked as being pressed down, it is still necessary to decide whether to mark the other side-keys having been marked as being pressed down before as being released. And then, the phone 16 updates pindex, pMiddle, pRing and pLittle with p41, p42, p43 and p44.

(B) If p33.x>pRing.x−avg*50%, then the left little finger releases, and the left little finger is marked as releasing. And later, if it is detected that four touch points are newly produced at the right side of the curved screen, then the left little finger presses down again, and the left little finger is marked as pressing down. The phone 16 sorts the four touch points from largest to smallest by x value into p41, p42, p43 and p44.

If pRing.x−avg*150%<p44.x<=pRing.x−avg*50%, then the left little finger presses down at the position of Punc, and Punc is marked as being pressed down.

If p44.x<=pRing.x−avg*150%, then the left little finger presses down at the position of Alt, and Alt and Punc are marked as being pressed down.

After the above corresponding side-key(s) is/are marked as being pressed down, it is still necessary to decide whether to mark the other side-keys having been marked as being pressed down before as being released. And then, the phone 16 updates pindex, pMiddle, pRing and pLittle with p41, p42, p43 and p44.

In the description of the above three parts, even though situations that a side-key is double-clicked or triple-clicked and multiple side-keys are operated simultaneously are not described, obviously, the present invention can also realize these operations. And the present invention can also apply to more methods operating a side-key disclosed in the PCT application mentioned in the background art.

Part D. FIG. 31 is a slide mobile phone configured with a three*five matrix physical keyboard and its side-key layout is the same as the phone 1's. Keyboard layouts corresponding to its partial side-keys and side-key combinations are shown as FIG. 33-38. FIG. 32 is a flip mobile phone configured with a four*four matrix physical keyboard and its side-key layout is the same as the phone 1's. Keyboard layouts corresponding to its side-keys and side-key combinations are shown as FIG. 21-28.

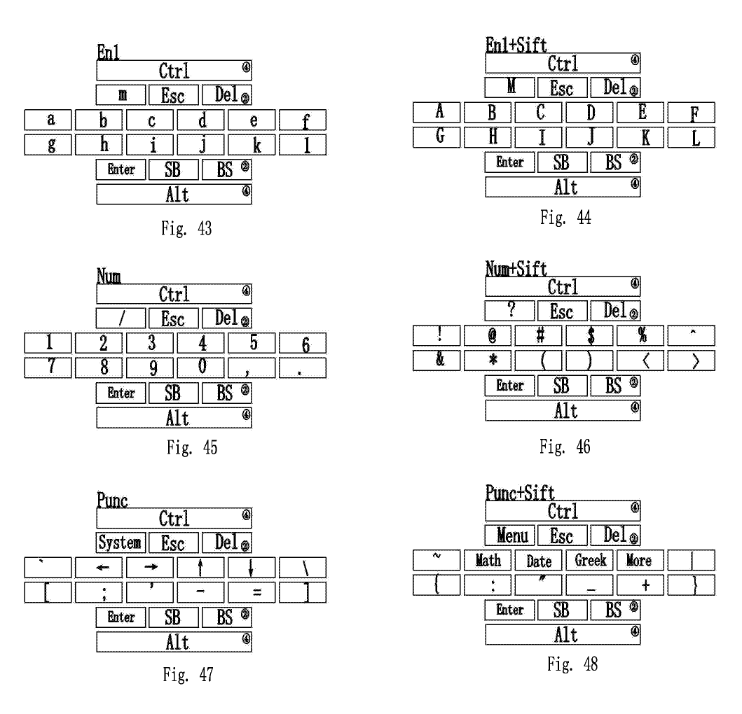

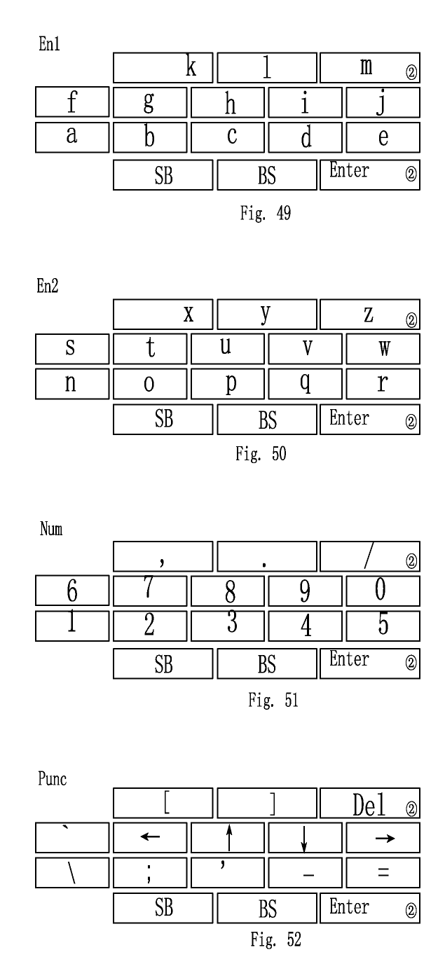

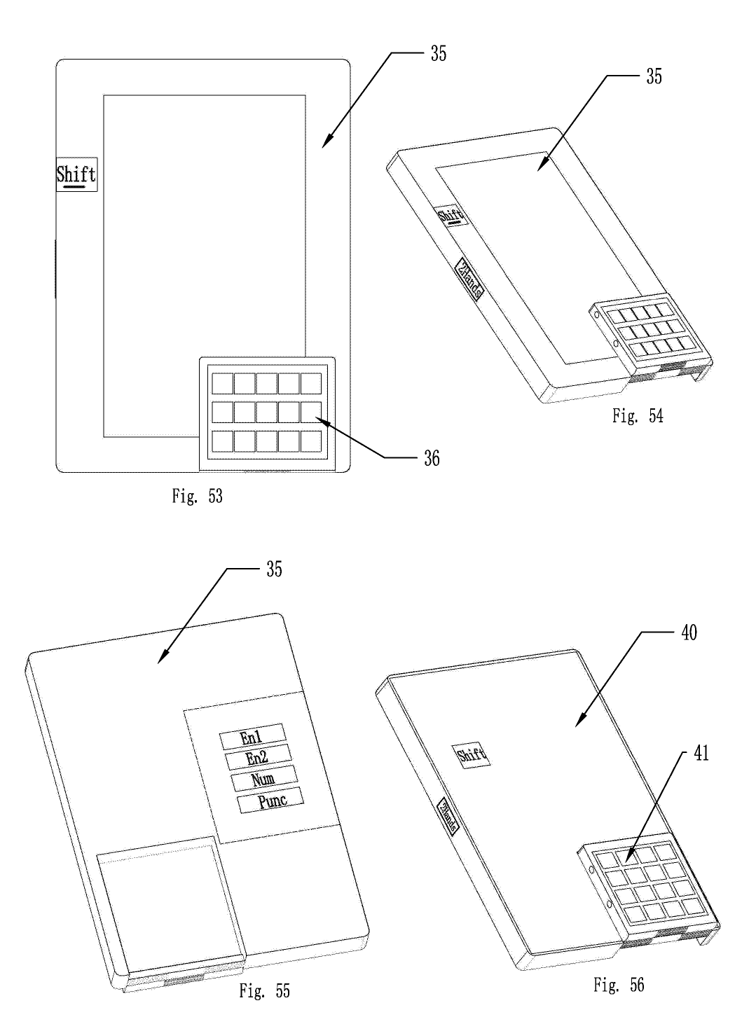

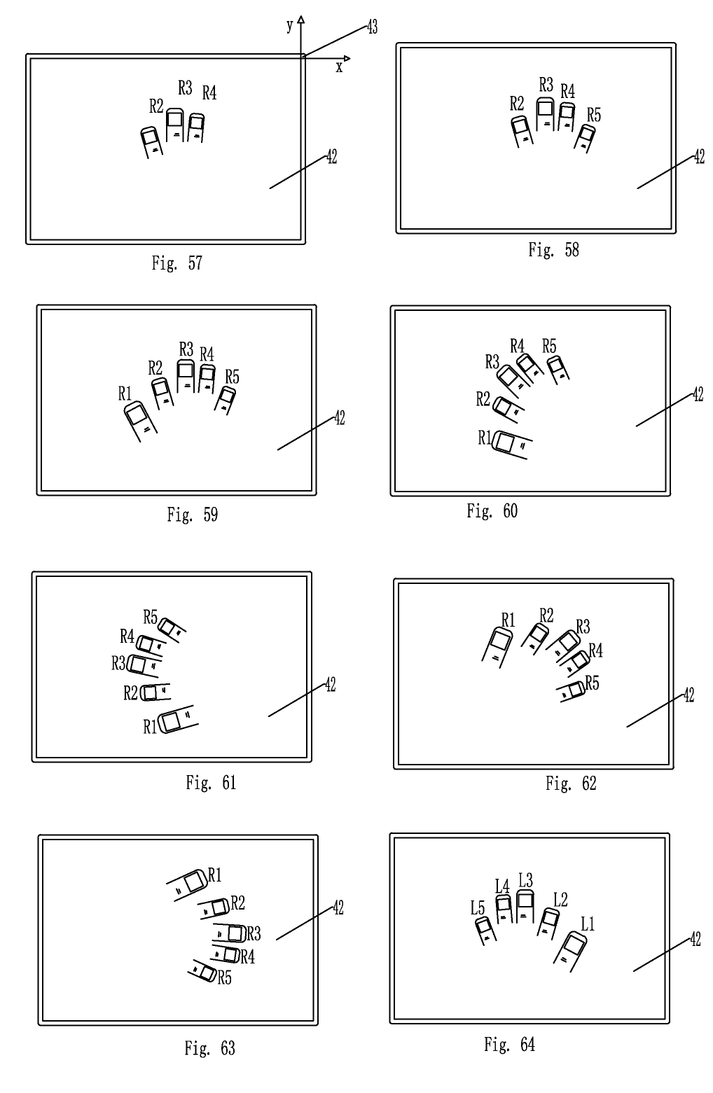

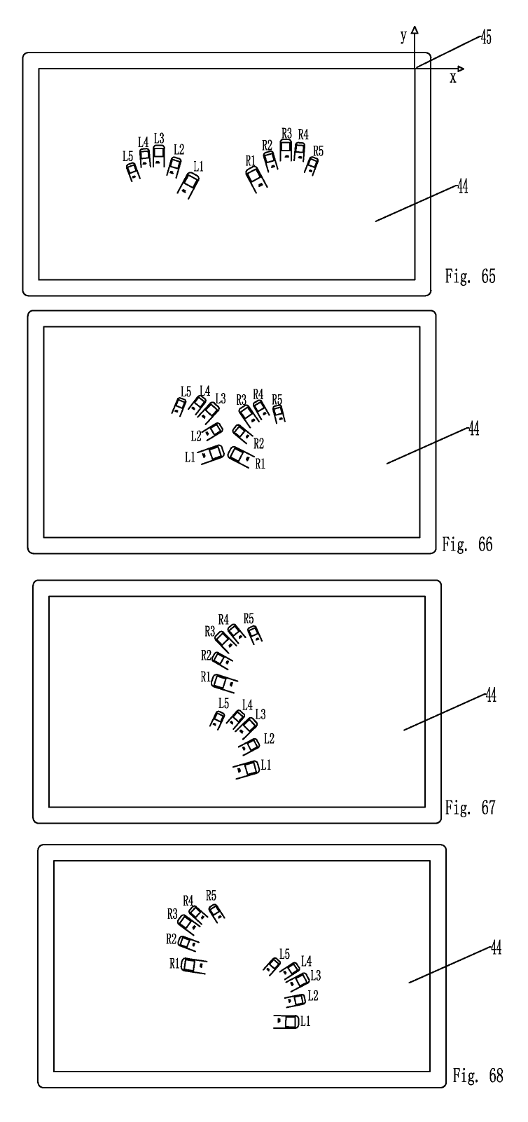

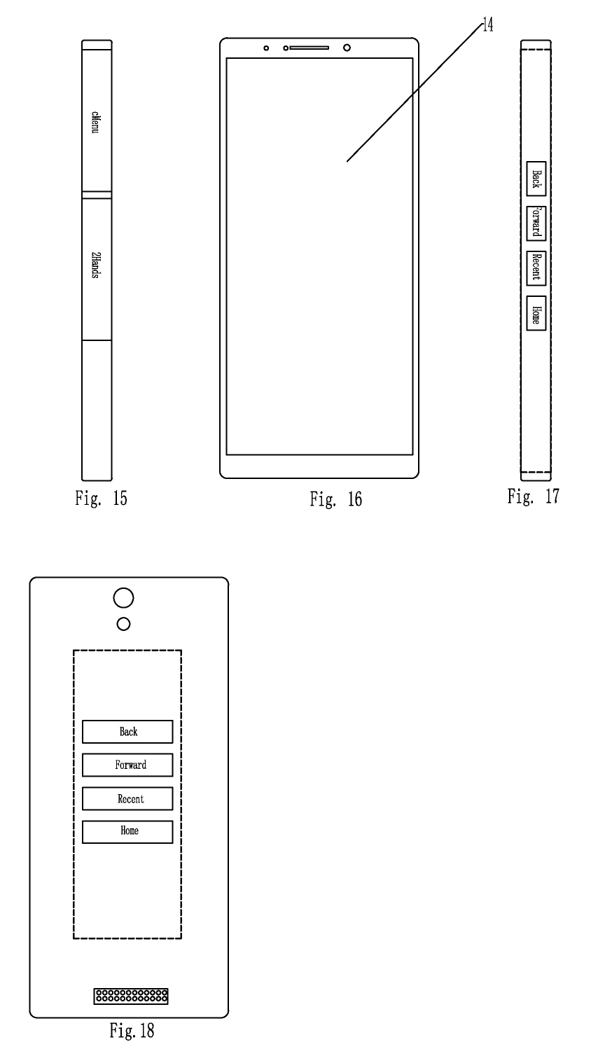

Part E. FIG. 39 is a tablet 24. A two*six matrix physical keyboard is configured at the tablet's bottom, Shift is configured on a frame of the upper left corner of the tablet, 2Hands is configured at the left side of the tablet, a multi-touch pad 28 is configured at the left of the tablet's back, a dynamically keyboard-mapping area is configured on the tablet's touch screen. Keyboard layouts corresponding to its partial side-keys and side-key combinations are shown as FIGS. 43-48. A user holds the tablet 24 by his/her left hand at the left side, and the left thumb holds at the position of Shift, 2Hands is touched and pressed naturally by the root bulge of the left thumb, the left index, middle, ring and little fingers hold the touch pad 28 at the left of the tablet's back. Four touch points produced at the touch pad correspond to En1, En2, Num and Punc side-keys respectively.

FIG. 42 is a frameless tablet 29. A two*five matrix physical keyboard is configured at the tablet's bottom, a dynamically keyboard-mapping area is configured on the tablet's touch screen. Except Shift is configured at the upper left corner of the tablet's touch screen, its side-key layout is the same as the tablet 24's. Keyboard layouts corresponding to its partial side-keys and side-key combinations are shown as FIG. 49-52. A grip hold-point disclosed in a PCT application “A Frameless Tablet Computer” with a publication No. WO/2014/101519 can be used as Shift side-key of the present tablet and a touch action on the grip hold-point can be used as an operation of Shift side-key.

FIG. 53 is a flip physical-keyboard tablet 35. A keyboard 36 uses three*five matrix and is connected with the tablet by a plurality of connection ribbons. When the keyboard is not in use, it can be flipped into the back of the tablet. If the keyboard 36 is transparent, keyboard layouts shown as FIGS. 33-38 and the other non-illustrated keyboard layouts can be displayed dynamically on the tablet's touch screen under the keyboard. The tablet 35's side-key layout is the same as the tablet 24's.

FIG. 56 is a flip physical-keyboard frameless tablet 40. A keyboard 41 uses four*four matrix. The tablet 40's side-key layout is the same as the tablet 29's. Keyboard layouts corresponding to its side-keys and side-key combinations are shown as FIG. 21-28.

The above-mentioned side-keys for a keyboard can be reused as keys/buttons with the other functions when in a non-edit mode or in a non-shortcut mode, or can be reused as keys/buttons with the other functions via double-click or even triple-click. Shown as the phone 14, side-keys configured on a multi-touch pad do not have to be used as side-keys of a keyboard. Obviously, besides mobile phones and tablets, the present invention is also applicable to the other similar handheld digital devices. When a handheld digital device is larger for a user's left index and/or little finger(s) not to be able to reach a touch pad configured at the right side, so that sufficient side-keys cannot be configured on the touch pad, the touch pad can be extended properly toward the back of the handheld digital device in order for the index and/or little finger(s) to be able to reach it. A touch pad configured at the left side or the back's right of a handheld digital device can apply to a lefty.

Part F. An independent multi-touch pad/screen can also realize a plurality of keys/buttons which positions are determined dynamically and passively. A touch pad mouse 42 is shown as FIG. 57-64, multiple fingers can move, pinch and rotate etc. on it at the same time. FIGS. 57, 58 and 59 are respectively situations that 3/4/5 mouse buttons are realized by a right hand's 3/4/5 fingers. R1, R2, R3, R4 and R5 in the Figures respectively represent a right hand's thumb, index, middle, ring and little fingers. FIG. 64 is a situation that five mouse buttons are realized by a user's five left fingers on the touch pad mouse 42, wherein L1, L2, L3, L4 and L5 respectively represent the left thumb, index, middle, ring and little fingers. Because all or most of the fingers rest on the touch pad mouse for the wrist not to have to bend upward, the fingers' and wrist's fatigue can be relieved greatly.

An embodiment that five mouse buttons are realized by a right hand on the touch pad mouse 42 is taken as an example to describe in the following. Let R1, R2, R3, R4 and R5 correspond to the fourth, left, middle, right and fifth mouse buttons respectively. When a right hand's five fingers touch the touch pad mouse 42, five touch points p51, p52, p53, p54 and p55 are produced. According to a coordinate system 43, a mouse firmware sorts p51-p55 from smallest to largest by x value into pX1, pX2, pX3, pX4 and pX5, and from largest to smallest by y value into pY1, pY2, pY3, pY4 and pY5, and marks R1, R2, R3, R4 and R5 as pressing down at the same time.

If pY1=pX3, then the right hand's initial touch gesture is shown as FIG. 59, so pX1, pX2, pX3, pX4 and pX5 respectively correspond to the touch points of R1, R2, R3, R4 and R5. And then, the mouse firmware stores pX1, pX2, pX3, pX4 and pX5 as pThumb, pindex, pMiddle, pRing and pLittle, and activates the mouse buttons.

If pY1=pX4, then the right hand's initial touch gesture is shown as FIG. 60, so pY5, pY4, pX3, pX4 and pX5 respectively correspond to the touch points of R1, R2, R3, R4 and R5. And then, the mouse firmware stores pY5, pY4, pX3, pX4 and pX5 as pThumb, pindex, pMiddle, pRing and pLittle, and activates the mouse buttons.

If pY3=pX1, then the right hand's initial touch gesture is shown as FIG. 61, so pY5, pY4, pY3, pY2 and pY1 respectively correspond to the touch points of R1, R2, R3, R4 and R5. And then, the mouse firmware stores pY5, pY4, pY3, pY2 and pY1 as pThumb, pindex, pMiddle, pRing and pLittle, and activates the mouse buttons.

If pY1=pX2, then the right hand's initial touch gesture is shown as FIG. 62, so pX1, pX2, pX3, pY4 and pY5 respectively correspond to the touch points of R1, R2, R3, R4 and R5. And then, the mouse firmware stores pX1, pX2, pX3, pY4 and pY5 as pThumb, pindex, pMiddle, pRing and pLittle, and activates the mouse buttons.

If pY3=pX5, then the right hand's initial touch gesture is shown as FIG. 63, so pY1, pY2, pY3, pY4 and pY5 respectively correspond to the touch points of R1, R2, R3, R4 and R5. And then, the mouse firmware stores pY1, pY2, pY3, pY4 and pY5 as pThumb, pindex, pMiddle, pRing and pLittle, and activates the mouse buttons.

After activating the mouse buttons, following moving of the fingers on the touch pad mouse 42, the mouse firmware continuously updates pThumb, pindex, pMiddle, pRing and pLittle with a nearest new touch point to their respective, or continuously updates pThumb, pindex, pMiddle, pRing and pLittle through the above-described method.

Assuming that the touch pad mouse 42 is a 3D multi-touch pad mouse, each touch point is represented by coordinates (x, y, p).

When there is a finger releasing and the number of the touch points changes from five to four, assuming that the remaining four touch points are p41, p42, p43 and p44, and

(a) comparing p41, p42, p43 and p44 with pThumb respectively, if x and y of any of them are not equal to x and y of pThumb respectively, then the touch point corresponding to R1 i.e. pThumb is lost, and later on, if detecting that five touch points are produced newly on the mouse 42, then R1 presses down again, the mouse firmware sends a fourth mouse button click command, and updates pThumb with new touch point.

(b) comparing p41, p42, p43 and p44 with pindex respectively, if x and y of any of them are not equal to x and y of pindex respectively, then the touch point corresponding to R2 i.e. pindex is lost, and later on, if detecting that five touch points are produced newly on the mouse 42, then R2 presses down again, the mouse firmware sends a left mouse button click command, and updates pindex with new touch point.

(c) comparing p41, p42, p43 and p44 with pMiddle respectively, if x and y of any of them are not equal to x and y of pMiddle respectively, then the touch point corresponding to R3 i.e. pMiddle is lost, and later on, if detecting that five touch points are produced newly on the mouse 42, then R3 presses down again, the mouse firmware sends a middle mouse button click command, and updates pMiddle with new touch point.

(d) comparing p41, p42, p43 and p44 with pRing respectively, if x and y of any of them are not equal to x and y of pRing respectively, then the touch point corresponding to R4 i.e. pRing is lost, and later on, if detecting that five touch points are produced newly on the mouse 42, then R4 presses down again, the mouse firmware sends a right mouse button click command, and updates pRing with new touch point.

(e) comparing p41, p42, p43 and p44 with pLittle respectively, if x and y of any of them are not equal to x and y of pLittle respectively, then the touch point corresponding to R5 i.e. pLittle is lost, and later on, if detecting that five touch points are produced newly on the mouse 42, then R5 presses down again, the mouse firmware sends a fifth mouse button click command, and updates pLittle with new touch point.

Or when the mouse firmware detects that a touch point's p value changes, referring to the description of the above Part C, the mouse firmware determines a currently operating finger and sends a corresponding mouse button click command. For example, if the mouse firmware detects that pRing's p value changes and R4 presses with a larger force, then R4 is operating, and then if detects that pRing's p value changes again and R4 naturally touches the touch pad mouse 42 again, the mouse firmware sends a right mouse button click command and updates pThumb, pindex, pMiddle, pRing and pLittle at the same time. Therefore, on a 3D multi-touch pad, the above two methods can be used simultaneously to realize a key/button operation.

The embodiments in FIGS. 57, 58 and 64 can also be realized through the above methods.

According to the above methods, a plurality of fingers can also be used to simulate a mouse on a multi-touch screen; a tablet with a multi-touch function can also be reformed into a mouse, and for some tablets, for example, some tablets supporting Bluetooth 4.0 and higher, perhaps it is sufficient only to write a specialized mouse App to interpret fingers' operations on a tablet's touch screen into mouse operations.

Part G. For a large multi-touch screen/pad, all or part of a user's two hands' ten fingers can be used simultaneously to touch the touch screen/pad to realize moving, pinching and rotating operations etc. and also realize more keys/buttons which positions are determined dynamically and passively.

A large touch-screen display device 44 is shown as FIGS. 65-68. When a user first uses the device 44, the user is prompted to use his/her two hands to touch the device 44 as FIG. 65, and then according to every five touch points of the user's left and right hands, two virtual arcs aL0 and aR0 are figured out respectively, and an average value r0 of both aL0 and aR0's radiuses is figured out and stored in the device 44.

After the user uses the device 44 normally, when ten touch points are detected on the touch screen, according to a coordinate system 45, the device 44 sorts the ten touch points from smallest to largest by x value into pL1, pL2, pL3, pL4, pL5 and pR1, pR2, pR3, pR4, pR5. And then according to pL1-pL5 and pR1-pR5, the device 44 figures out two virtual arcs aL and aR, and compares aL's radius rL and aR's radius rR with r0 respectively.

If one or both of rL and rR is very different form r0, then the two hands' touch gesture on the device 44 is shown as FIG. 67 and is incorrect, a prompt should be given to the user to correct.

If both of rL and rR are approximate to r0, but the center of aL is at the right of aL and the center of aR is at the left of aR, then the two hands' touch gesture on the device 44 is shown as FIG. 68, and then by swapping pL1-pL5 and pR1-pR5, the gesture is deemed to be correct.

If both rL and rR are approximate to r0, and the centers of aL and aR are under aL and aR respectively, then the two hands' touch gesture on the device 44 is shown as FIG. 65 and is correct.

If both rL and rR are approximate to r0, and the center of aL is at the left of aL and the center of aR is at the right of aR, then the two hands' touch gesture on the device 44 is shown as FIG. 66 and is correct.

After determining that the user's touch gesture is correct, according to the method disclosed in the above Part F, pL1, pL2, pL3, pL4, pL5 and pR1, pR2, pR3, pR4, pR5 are matched respectively with L1, L2, L3, L4, L5 and R1, R2, R3, R4, R5 one to one, and in the subsequent operations, the coordinates of each touch point corresponding to each finger should be updated timely following the finger's moving. When there is a finger operating a key/button, according to the methods disclosed in the above Part A, B, C and F, an operating finger is first determined, and then a corresponding key/button is determined accordingly.

When it is not required to configure keys/buttons as many as touch points on a multi-touch pad/screen, the keys/buttons not to be used can be ignored. For example, for the touch pad mouse shown as FIG. 59, when not all of the five mouse buttons is required, the button(s) not to be used can be ignored. Shown as the curved screen mobile phone 16, the above description about a multi-touch pad is also applicable to a multi-touch screen, and vice versa. The above methods realizing a plurality of keys/buttons on a multi-touch pad/screen, not only realize dynamic and passive determination of the keys/buttons' positions, but also realize determining a key/button by a corresponding finger, i.e., it is sufficient for a user only to remember each key/button's corresponding finger, because a finger's action is an operation of a corresponding key/button.

For better user experience, each of the above-mentioned keys/buttons can be combined with vibration, bell and/or tactile feedback.

In the above-described embodiments, besides a multi-touch pad(s)/screen(s), in general, a computing unit(s) like CPU/MCU etc., a storage unit(s) like RAM, ROM and/or disk etc., peripherals and sensors etc. are involved.

1. A method realizing a plurality of keys/buttons which positions are determined dynamically and passively, when a user's one hand's or two hands' multiple fingers hold or touch a multi-touch pad/screen, a plurality of touch points will be produced, and are regarded as keys/buttons,
wherein when all the fingers release and leave the multi-touch pad/screen, make the keys/buttons' positions pending.

2. The method realizing a plurality of keys/buttons which positions are determined dynamically and passively as claimed in claim 1, wherein a key/button is associated with a finger via a touch point.

3. The method realizing a plurality of keys/buttons which positions are determined dynamically and passively as claimed in claim 1, wherein a position of at least one of the keys/buttons is determined only after a corresponding finger holds or touches the multi-touch pad/screen.

4. The method realizing a plurality of keys/buttons which positions are determined dynamically and passively as claimed in claim 1, wherein losing and regaining of a touch point corresponding to a finger is regarded as an operation of a corresponding key/button.

5. The method realizing a plurality of keys/buttons which positions are determined dynamically and passively as claimed in claim 1, wherein changing of a coordinate value representing a finger's press force of a touch point corresponding to a finger is regarded as an operation of a corresponding key/button.

6. The method realizing a plurality of keys/buttons which positions are determined dynamically and passively as claimed in claim 1, wherein after an operation of a key/button ends, a corresponding finger still holds or touches the touch pad/screen.

7. The method realizing a plurality of keys/buttons which positions are determined dynamically and passively as claimed in claim 1, wherein any unused touch point or key/button is ignored.

8. The method realizing a plurality of keys/buttons which positions are determined dynamically and passively as claimed in claim 1, wherein a handheld digital device with a multi-touch function is reformed into a mouse.
